(19) United States
(12) Patent Application Publication
(10) Pub. No.: US 2014/0304173 A1
(43) Pub. Date: Oct. 9, 2014

(54) Methods and Systems for Keyless Vehicle Dispatch

(71) Applicant: Trapeze Software ULC, Mississauga (CA)

(72) Inventor: Paul Anthony Ernsdorff, Spokane, WA (US)

(73) Assignee: Trapeze Software ULC, Mississauga (CA)

(21) Appl. No.: 14/247,724

(22) Filed: Apr. 8, 2014

Related U.S. Application Data
(60) Provisional application No. 61/809,520, filed on Apr. 8, 2013.

(51) Int. Cl. G06Q 10/02; G06Q 20/38; B60R 25/01; G06Q 50/30

(52) U.S. Cl. CPC G06Q 10/02; G06Q 50/30; G06Q 20/382; B60R 25/01
USPC 705/76; 705/13

(57) ABSTRACT

A system for providing a driver, having a driver communication device, access to a vehicle using an electronic key, the system comprising a fleet control center, comprising an asset application and a database, configured to, allow creation of a reservation for the vehicle for the driver and store the reservation in the database, create a keyless asset tag to allow the driver to access the vehicle, communicate the keyless asset tag to the driver computing device, and a vehicle computing device, proximate to the vehicle, and configured to, obtain the keyless asset tag from the driver computing device, determine if the keyless asset tag is valid for the vehicle, and cause a vehicle door to be unlocked to provide the lessee access to the vehicle.

### FIELD OF THE INVENTION

The present invention relates generally to vehicle dispatch. More particularly, the present invention relates to systems and methods for keyless vehicle dispatch with related security or audit features.

### BACKGROUND OF THE INVENTION

Motor pools, rental vehicles, or fleets of corporate or public vehicles, (collectively “fleets”), are frequently used where multiple vehicles may be used by multiple people. One of the problems experienced with fleets is the distribution of keys.

Physical keys have many disadvantages, such as copying, returning after use, drop-off of vehicles remote from pick-up, and the like.

Although alternatives to physical keys have been developed, they are often difficult or expensive to implement and generally require capital and/or on-going outlays from the fleet operator. Further, they often fail to address audit requirements of the fleet operator, such as knowing how a particular operator used the vehicle (distance, operating parameters, and the like).

It is therefore an object of the invention to provide a novel method and system for keyless vehicle dispatch.

### SUMMARY OF THE INVENTION

According to one embodiment of the invention, there is disclosed a system for providing a driver, having a driver communication device, access to a vehicle using an electronic key. The system includes a fleet control center, having an asset application and a database, configured to allow creation of a reservation for the vehicle for the driver and store the reservation in the database, create a keyless asset tag to allow the driver to access the vehicle and to communicate the keyless asset tag to the driver computing device. The system also includes a vehicle computing device, proximate to the vehicle, and configured to obtain the keyless asset tag from the driver computing device, determine if the keyless asset tag is valid for the vehicle and to cause a vehicle door to be unlocked to provide the lessee access to the vehicle.

According to one aspect of this first embodiment, the vehicle computing device is located inside the vehicle, the driver computing device is located outside the vehicle and obtaining the keyless asset tag is by the vehicle computing device scanning the keyless asset tag from a screen of the driver computing device.

According to another aspect of this first embodiment, the determining if the keyless asset tag is valid includes reading information from the keyless access tag and comparing the information to a database of information indicative of a valid keyless access tag.

According to another aspect of this first embodiment the reading further includes decrypting the information from the keyless access tag.

According to another aspect of this first embodiment the determining if the keyless asset tag is valid includes reading information from the keyless access tag and running an algorithm on the information.

According to a second embodiment of the invention, there is disclosed a driver communication device, to drive a vehicle using an electronic key, the system including a fleet control center, having an asset application and a database, configured to receive a current vehicle odometer value from the driver communication device, determine if the current vehicle odometer value is valid. If the vehicle odometer is valid, the control center is further configured to create an ignition keyless tag to allow the driver to access the vehicle and to communicate the ignition keyless tag to the driver computing device. The system further includes a vehicle computing device, proximate to the vehicle, and configured to obtain the ignition keyless tag from the driver computing device, determine if the ignition keyless tag is valid for the vehicle and to cause the vehicle to be able to be started by the driver.

According to one aspect of this second embodiment, the determining if the ignition keyless tag is valid includes reading information from the ignition keyless tag and comparing the information to a database of information indicative of a valid ignition keyless tag.

According to another aspect of this second embodiment, the reading further includes decrypting the information from the ignition keyless tag.

According to another aspect of this second embodiment, the determining if the ignition keyless tag is valid includes reading information from the ignition keyless tag and running an algorithm on the information.

### BRIEF DESCRIPTION OF THE DRAWINGS

Embodiments will now be described, by way of example only, with reference to the attached Figures, wherein:

FIG. 1 shows a system for keyless dispatching of vehicles in accordance with an embodiment of the invention and its operating environment;

FIG. 2 shows a method for a lessee to obtain access to a vehicle in a fleet according to an embodiment of the invention;

FIG. 3 shows a method for a lessee to begin operating a vehicle in a fleet, according to an embodiment of the invention; and

FIG. 4 shows a method for a lessee to end operating a vehicle in a fleet, according to an embodiment of the invention.

### DETAILED DESCRIPTION OF THE EMBODIMENTS

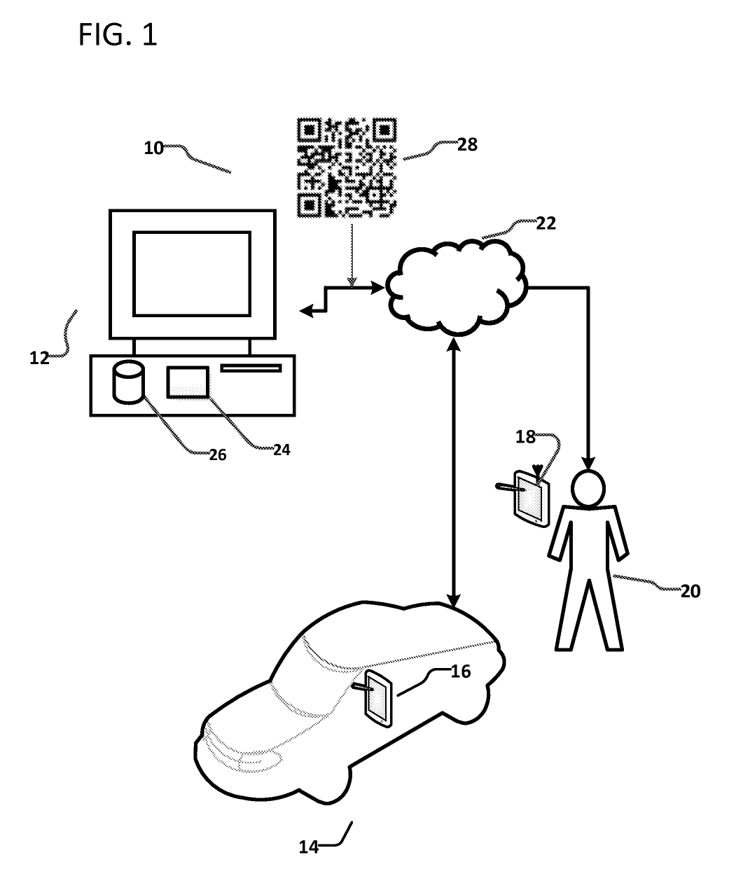

FIG. 1 shows a system 10 for keyless dispatching of vehicles comprising vehicle 14, further comprising mobile data terminal (MDT) (which may also be referred to as vehicle communication device—VCD) 16, communication network 22, fleet control center (“FCC”) 12 which may further comprise transit/asset software (or application) 24, and database 26, driver/lessee 20, driver communication device (DCD) 18, and keyless asset tag 28.

Vehicle 14 is a vehicle that provides, or relates to the provision of, transit services. Vehicle 14 may be a normal car or van, or may be somewhat more specialized such as a bus, ATV, or piece of equipment. Vehicle 14 may be used by more than one driver, or otherwise have a need not to be started exclusively by a physical key. In one particular embodiment, vehicle 14 may be a car in a fleet of cars owned by a corporation and used by renters or employees.

Vehicle 14 may have many systems running thereon, as typical of vehicles such as cars. Exemplary systems may include electronic locks, ignition, windows, radio, electronic odometers and the like, as are known to those of skill in the art (and not shown).

Vehicle 14 also has MDT 16 thereon or therein, also referred to herein as vehicle computing device 16, though possibly being removable therefrom. MDT 16 may be used to perform various functions relating to the operation of vehicle 14 or a fleet of vehicles. MDT 16 may be configured to communicate with various systems on vehicle 14. In particular, MDT 16 may be able to interact with such systems so as to unlock and/or open vehicle's 14 doors, start the engine, or otherwise render vehicle 14 able to be driven or otherwise begin operating and moving (such as by a self-driven vehicle).

MDT 16 may be powered by a battery or similar power source and may be configured to use one or more renewable sources to power the battery or power source (such as photovoltaic cells that power a battery) so that MDT 16 can remain in vehicle 14, without requiring any manual intervention.

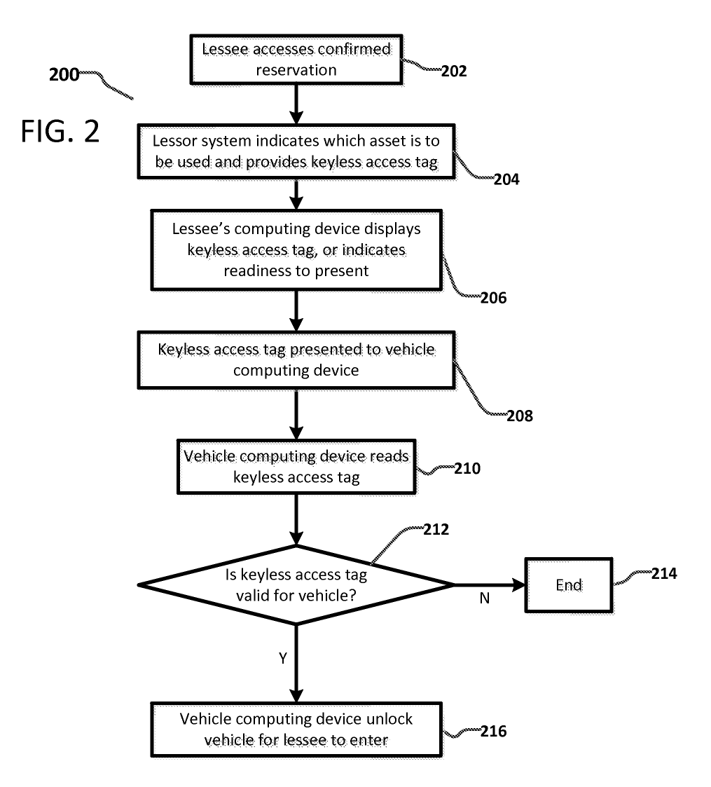

MDT 16 may have software running thereon to accept inputs as described herein, provide outputs as described herein, and communicate with other elements of system 10 as described herein. MDT 16 may have features of many tablets, smartphones, rugged PCs, and the like, some of which are shown in FIG. 2, such as one or more screens, memory, processors, cameras, communication modules (Bluetooth, RFID, cellular, WiFi, NFC, etc), and user inputs (touchscreens, buttons, etc).

MDT 16 may be able to communicate with other elements of system 10, for example by communication network 22, or directly such as may be the case with other systems of vehicle 14 or DCD 18.

Fleet control center 12, which may also be referred to as a lessor system, may be a system for operating one or more transit services, fleet of vehicles 14 (such as by a fleet operator or rental company), or the like. FCC may be implemented via one or more software components, and may be used by one or more transit agencies or fleet operators. Fleet control center 12 may further comprise fleet software 24 and database 26, which may provide the logic and storage to implement other features of software that may be required by fleet operators, such as making bookings or reservations, maintenance requests and schedules. One exemplary fleet control center 12, and fleet software 24 may be AssetWorks' Reservations Portal, M5 or Enterprise Asset Management products, though any reservations system may be used. Fleet control center 12 may communicate, via communication network 22, with vehicle 14 and rider communication device 18, as needed, to implement the functionality described herein.

MDT 16 and DCD 18 may be computing devices that may take user or other inputs (such as keystrokes, clicks, touch inputs, image recognition results and the like) and provides the user interface to functionality relating to the provision of transit or asset-tracking services, and interacting with FCC and the software located thereon (such as transit software 24 and incident module 24a). Exemplary MDTs 22 and DCDs 18 include mobile phones, tablets, laptops (that may be running Windows™ or iOS™ operating systems, for example), ruggedized laptops, vendor specific devices (such as Android™ Blackberry™ or Apple™ products).

Communication network 22 may be substantially any public or private network, wired or wireless, and may be substantially comprised of one or more networks that may be able to facilitate communication between themselves. Communication network 22 may facilitate various types of communication, such as cellular, WiFi, and the like, or it may not be required as elements of system 10 may communicate directly between themselves.

Driver or lessee 20 may be substantially any person, client, customer, or entity using one or more of the services being offered by the fleet operator or using vehicle 14. Driver 20 may have an DCD 18 to interact with aspects of system 10.

Keyless asset tag 28 may be a non-physical ‘key’ that enables a lessee to access vehicle 14. KAT 28 may be communicated to DCD 18 and subsequently communicated to VCD 16 to allow such access. KAT 28 may be text, a QR code, bar code, a code or password, image, video or any other signal that can be communicated to vehicle computing device 16. In one embodiment KAT may be substantially any non-physical piece of information that can be communicated to vehicle computing device 16 without having to be in physical contact with vehicle computing device 16 (as at this stage the driver may be outside of vehicle 14). In another embodiment vehicle computing device 16 may allow direct interact with rider 20 and/or driver communication device 18, which may allow KAT to take other forms.

KAT 28 may include information, or include a pointer to information, relating to the reservation, vehicle 14, lessee 20, and the like. Such information may comprise, for example, dates/times for which KAT 28 is valid (outside of which KAT 28 may be automatically rendered useless, an account, project, client that use of vehicle 14 is for (for example as one approach to enable tracking and attribution of expenses) vehicle and lessee identifiers, and the like. Any of such information may be read by VCD 16 and used as described herein. If KAT 28 includes information it may only be in machine-readable format and may include encrypted information, such that only VCD 16 may decrypt the information in KAT 28.

Each driver 20 may have one or more KATs 28, for example that are stored on DCD 18 and that may be used at varying times or whenever they desire. Such KATs 28 may allow, for example, a travelling driver to use KAT 28 that relates to the account, project, or client that their use of vehicle 14 is for at a particular time. In this way, VCD 16 may be able to track the use and eventually provide such information to FCC 12, for example if VCD was out of network coverage (or in expensive network coverage) and returns.

KAT 28 may be, or may be paired with, NFC information so that driver 20 can pay for use of vehicle 14 as they unlock vehicle 14. In such an embodiment MDT 16 may also be NFC enabled and receive payment from DCD 18.

Ignition keyless tag may be substantially similar to KAT 28, though primarily aimed at enabling vehicle 14 to be used.

FIG. 2 shows a method 200 for a lessee to obtain access to a vehicle in a fleet according to an embodiment of the invention.

Method 200 begins at 202 where the lessee access their confirmed reservation or booking. At 202 a lessee has already made a booking or reservation, such reservation may be made through a booking system as known in the prior art, that may form part of FCC 12, for example. It is of course to be understood that KAT 28 may be created and communicated at the time the reservation was made, just subsequent to the time vehicle 14 is to be used pursuant to the reservation, or any other time prior to use of vehicle 14. If communication may be difficult at a later time, KAT 28 may be immediately communicated to DCD 18 and may then include information so that KAT 28 only allows access to vehicle 14 for a certain time period.

At 204 lessor system, such as FCC 12, indicates which asset is to be used and provides a keyless access tag (“KAT”), to one or more of DCD 18 and MDT 16. The asset to be used may be, for example, vehicle 14 that is part of a fleet of vehicles 14 that are owned by a fleet operator (lessor).

Method 200 then proceeds to 206 where the lessee's computing device, such as DCD 18, displays the KAT or indicates its readiness to present KAT to vehicle computing device 18 (“displaying” being one envisioned way for KAT to eventually be presented to vehicle computing device 16). Indicating readiness may be via one or more indications to a user, through substantially any way that a MDT 16 or other computing device may communicate with its user (visual, auditory, vibration cues, etc.).

At 208, the KAT is presented to MDT 16. This may be done substantially as described herein and may use communication network 22, for example. Various components of MDT 16 may be used, such as cameras, NFC hardware, and the like. At 208, VCD 16 may be ‘asleep’ or otherwise not ready to be presented or obtain KAT 28. Various methods, as known in the art, may be used to allow MDT 16 to remain ‘asleep’ in between uses (such as to maintain battery power), while being responsive when driver 20 is ready—such as motion sensors, proximity detectors and the like, that may operate with little power or on an intermittent basis.

Continuing to 210, MDT 16 may read KAT, matching up with the approach to presenting in 208.

At 212 a determination is made whether the KAT is valid for vehicle 14. This determination may be made by MDT 16, for example. MDT 16 may have an algorithm for reading and interpreting KAT 28 (or information thereon), or list of valid KATs or pictures thereof (such as stored on MDT 16 or received from FCC 12), that allows a determination to be made without reference to any other system. Alternatively, MDT 16 may communicate, via communication network 22 for example, with FCC 12 to ensure that the KAT is valid for vehicle 14. Determination may involve reading information from KAT 28 (possibly including decrypting information from KAT 28). In one embodiment, MDT 16 may have a software application thereon that obtains the information from KAT 28 and deciphers it to know whether it is a valid KAT 28. Deciphering may involve comparing the information to known structures or organizations of information, information stored on MDT 16 (such as counters for the number of times vehicle 14 was started), or the like. In short MDT 16 may have the required ability to determine validity without reference to, or communication with, other entities or systems.

If the determination is made at 212 that the KAT is not valid, then method 200 continues, and ends, at 214.

If, however, the determination is made at 212 that the KAT is valid, then method 200 continues at 216 and the vehicle computing device, such as MDT 16, unlocks vehicle 14 for the driver to enter. This may be done by interacting with other systems of vehicle 14.

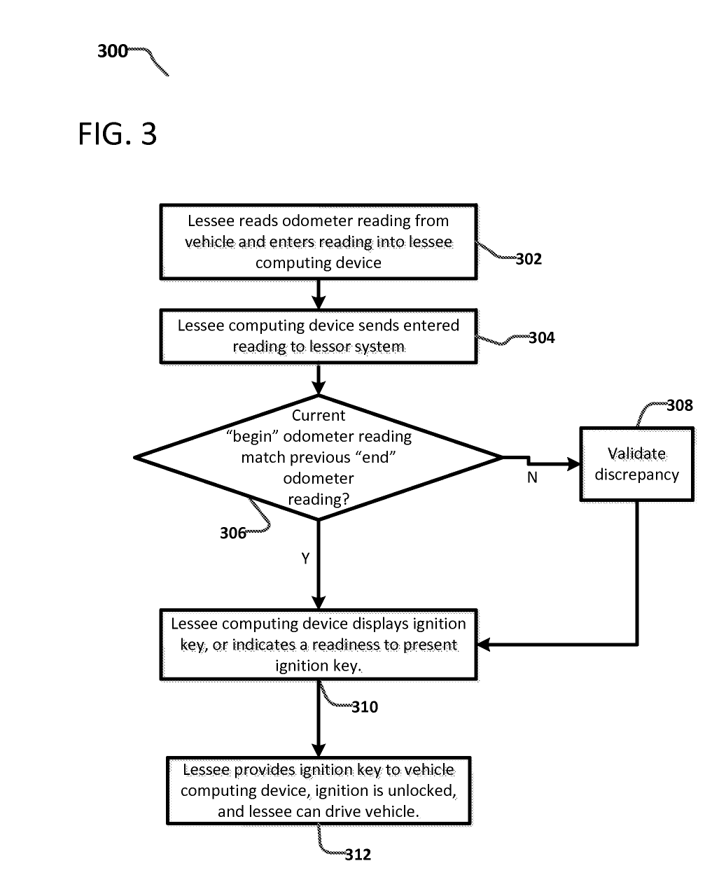

FIG. 3 shows a method 300 for a lessee to begin operating a vehicle in a fleet, according to an embodiment of the invention.

Method 300 begins at 302, after a driver or lessee has physically accessed vehicle 14, such as via method 200 of FIG. 2. At 302 the lessee reads the odometer from vehicle 14 and enters the reading into driver computing device 18. Reading the odometer may be possible without the ignition being engaged by the driver, or may require vehicle 14 to allow the ignition to be started enough for the odometer to be read but vehicle 14 not otherwise operated.

DCD 18 then accepts the entered odometer reading and sends the reading to lessor system, such as FCC 12, at 304. This may be done, for example, via communications network 22. It is noteworthy that in particular embodiments of the present invention MDT 16 does not have to communicate via communication network 22, thus not incurring any communication charges. Such communication, and communication charges may thus be avoided by fleet operator, and may be altogether avoided in some embodiments herein.

At 306 a comparison is made between the “begin” odometer reading (as entered by driver 20 at 302) and the previous “end” odometer reading (as entered by the last or most recent driver 20, as described herein).

MDT 16 may interact with systems on vehicle 14 to collect odometer readings during the use of vehicle 14 and send them to FCC 12. If systems on vehicle 14 do not allow for collection of odometer reading the odometer reading (either at the end of use or beginning of a new user's use) may be collected by lessee or lessor, for example. Such collection may allow further verification of odometer values.

It is to be understood that FCC 12 may be responsible for comparing the values, or DCD 18 may be responsible, though FCC 12 may be preferred to ensure privacy and control is maintained by the fleet operator.

If the two odometer values are equal, or within an acceptable range (that may be defined, for example by fleet operators), then method 300 continues to 310. If the two odometer values are not equal, or within an acceptable range, then method 300 continues at 308.

At 308, the discrepancy may be validated. A discrepancy may exist because either the prior driver or the current driver incorrectly entered the odometer reading (intentionally of accidentally), for example to reduce the charges they may have to pay, or to obscure an improper use of vehicle 14. This validation may be done, for example, by FCC 12 instructing MDT 16 to send the odometer reading, or the fleet operator sending an employee to the location of vehicle 14 to confirm an odometer reading (where such may cause vehicle 14 to be out of commission for some period of time). Alternatively, the new driver 20 may be asked to assume some risk of increased charges due to there being a discrepancy. Many options are available and are considered within the scope of the present invention.

In another embodiment, meter validation (which may involve some or all of 302-308) may not be required as a vehicle data collector (not shown) may retrieve, and communicate via communication network, all required meter information. Vehicle data collector may be similar to MDT 16; both may require at least intermittent access to communication network to perform validation.

In yet another embodiment, another validation may be performed at 304-308. For example, driver 20 may be required to enter information into DCD 18 (such as account information or the like, for tracking expenses as described herein), or authenticate that they are the driver associated with the reservation (such as by inputting a driver identifier, taking their picture, and the like) with MDT 16.

Continuing at 310, the odometer comparison (or other authentication, as described herein) having been successful, the lessee computing device (such as DCD 18) displays or otherwise indicates a readiness to present an ignition keyless tag to either driver 20 for entry, or directly to vehicle computing device 16. The methods of exchanging such ignition keyless tag may be substantially similar to the methods described herein and with respect to 206.

At 312 then the lessee provides the ignition keyless tag to vehicle computing device 16, the ignition is unlocked (or the unlocking is completed if it had been previously partially unlocked) and driver 20 can drive the vehicle.

Driver 20 may re-enter the code provided at 310, or a newly provided code (following a method similar to method 300) each time they want to turn on vehicle 14 (such as if they park briefly to make a stop, etc, in normal operation but not at the end of their lease or overall use).

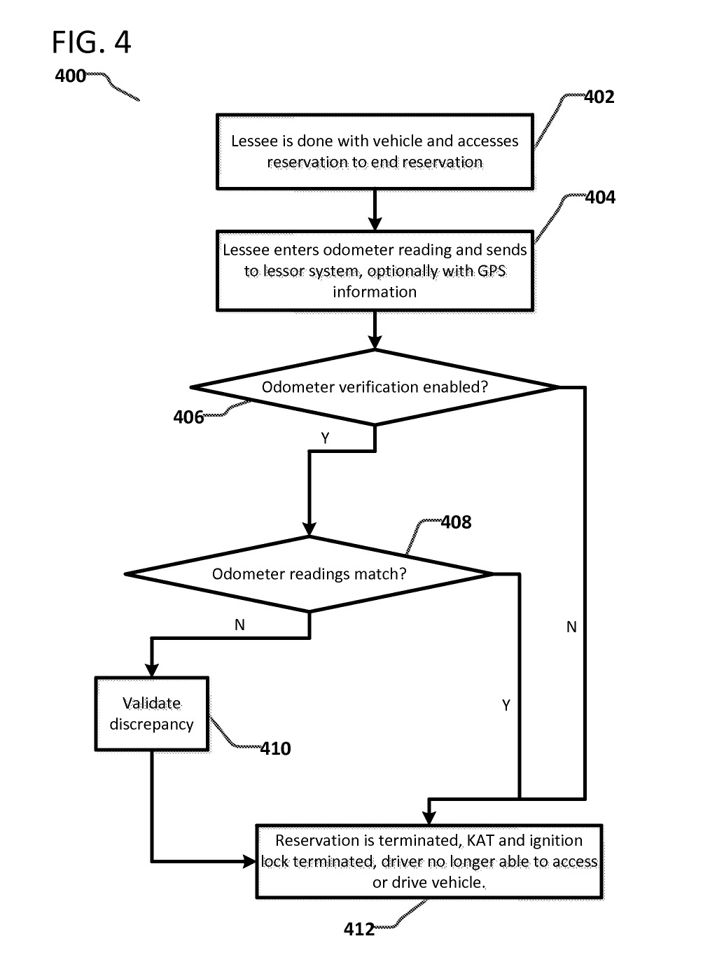

FIG. 4 shows a method 400 for a lessee to end operating a vehicle in a fleet, according to an embodiment of the invention.

Method 400 may be used when driver 20 is no longer going to be using vehicle 14 and/or anticipates another driver 20 to be the next driver of vehicle 14.

Method 400 begins at 402 where the lessee is done with vehicle 14 and accesses the reservation they had for vehicle 14. This accessing may be on their DCD 18.

At 404 the lessee enters the odometer reading of the vehicle and sends it to the lessor system. This may involve, for example, driver 20 entering the odometer reading into their DCD 18 and sending it to FCC 12 via communication network 22, for example. Alternatively the odometer reading may be provided to the lessor system in another manner, such as through the use of a vehicle data collector (or MDT 16), as described herein. The GPS location of the vehicle may also be sent, for example if DCD 18 has such capability and driver 20 enables or allows such. This may assist a fleet operator in knowing where vehicle 12 is, though they may also be able to rely on MDT 16 and its GPS capability, if it exists.

At 406 a determination is made whether odometer verification is enabled. This may be set, for example, by FCC 12 or by driver 20 via DCD 18. This may allow one or more parties to be sure that the odometer reading is correct, but may cause more communications charges to be incurred.

If odometer verification is enabled, method 400 proceeds to 408 to determine whether odometer readings match. The odometer readings to compare may be the reading entered at 404 and a reading by the other party to the transaction (generally fleet operator) that may be done via direct communication with MDT 16 (that is able to communicate with the odometer) or by an employee of the fleet operator physically visiting vehicle 14. If they match, or are within an acceptable range, then method 400 may continue to 412.

If they do not match, then the discrepancy may be validated at 410. This may involve a negotiation or involve both parties being physically present at vehicle 14. Although the odometer reading at vehicle 14 may be the conclusive reading, discrepancies or disputes may be resolved at 410.

Method 400 may arrive at 412 from 408 (if odometer readings match), 410 (after validating the discrepancy) or 406 (if no odometer verification is enabled or required). At 412 the reservation is terminated and final charges or other statistics (such as distance driven, number of days or hours of operation, etc) are calculated. Driver 20 may no longer be able to access vehicle 14, and thus the KAT and ignition keyless tags that allowed driver 20 to access and operate vehicle 14 may be terminated. Vehicle 14 is then ready for a further reservation and driver 20 that is terminating would become the prior, previous or most recent driver.

The methods described herein, in particular when used in conjunction with GPS functionality, may allow vehicles 14 to be “returned” to a fleet operator by parking it in any location. There would not need to be any dependency on MDT 16 being able to communicate with a communication network 22, or a communication network controlled by fleet operator. Provide a new driver 20 could use their DCD 18, and ideally access a public communication network 22, any location could be an end location (and hence become a start location for a subsequent driver 20).

It is to be understood that the screenshots herein are meant as examples only, and the fields, user interface elements, and workflows suggested are examples only. Many variations thereon are considered within the scope of the present invention.

Computer-executable instructions for implementing the software described herein, including fleet software 24, on a computer system could be provided separately from the computer system, for example, on a computer-readable medium (such as, for example, an optical disk, a hard disk, a USB drive or a media card) or by making them available for downloading over a communications network 22, such as the Internet. Such computer-executable instructions may be executed by one or more processors that may form part of elements of system 10.

While the computer system is shown as a single physical computer, it will be appreciated that the computer system can include two or more physical computers in communication with each other. Accordingly, while the embodiment shows the various components of system 10, and FCC 12 residing on the same physical computer, those skilled in the art will appreciate that the components can reside on separate physical computers.

The above-described embodiments are intended to be examples of the present invention and alterations and modifications may be effected thereto, by those of skill in the art, without departing from the scope of the invention that is defined solely by the claims appended hereto.

What is claimed is:

1. A system for providing a driver, having a driver communication device, access to a vehicle using an electronic key, the system comprising:
a fleet control center, comprising an asset application and a database, configured to:
allow creation of a reservation for the vehicle for the driver and store the reservation in the database;
create a keyless asset tag to allow the driver to access the vehicle;
communicate the keyless asset tag to the driver computing device; and
a vehicle computing device, proximate to the vehicle, and configured to:
obtain the keyless asset tag from the driver computing device;
determine if the keyless asset tag is valid for the vehicle; and
cause a vehicle door to be unlocked to provide the lessee access to the vehicle.

2. The system of claim 1 wherein the vehicle computing device is located inside the vehicle, the driver computing device is located outside the vehicle and obtaining the keyless asset tag is by the vehicle computing device scanning the keyless asset tag from a screen of the driver computing device.

3. The system of claim 1 wherein determining if the keyless asset tag is valid comprises:
reading information from the keyless access tag; and
comparing the information to a database of information indicative of a valid keyless access tag.

4. The system of claim 1 wherein reading further comprises decrypting the information from the keyless access tag.

5. The system of claim 1 wherein determining if the keyless asset tag is valid comprises:
reading information from the keyless access tag; and
running an algorithm on the information.

6. A system for allowing a driver, having a driver communication device, to drive a vehicle using an electronic key, the system comprising:
a fleet control center, comprising an asset application and a database, configured to:
receive a current vehicle odometer value from the driver communication device;
determine if the current vehicle odometer value is valid; and
if valid:
create an ignition keyless tag to allow the driver to access the vehicle; and
communicate the ignition keyless tag to the driver computing device; and
a vehicle computing device, proximate to the vehicle, and configured to:
obtain the ignition keyless tag from the driver computing device;
determine if the ignition keyless tag is valid for the vehicle; and
cause the vehicle to be able to be started by the driver.

7. The system of claim 6 wherein determining if the ignition keyless tag is valid comprises:
reading information from the ignition keyless tag; and
comparing the information to a database of information indicative of a valid ignition keyless tag.

8. The system of claim 6 wherein reading further comprises decrypting the information from the ignition keyless tag.

9. The system of claim 6 wherein determining if the ignition keyless tag is valid comprises:
reading information from the ignition keyless tag; and
running an algorithm on the information.
